(19) United States
(12) Patent Application Publication
(10) Pub. No.: US 2020/0394693 A1
(43) Pub. Date: Dec. 17, 2020

(54) COMPUTER-IMPLEMENTED PURCHASER PRIORITIZATION SYSTEM AND METHOD

(71) Applicant: KCH Innovations PTY LTD, Brisbane, Queensland (AU)

(72) Inventor: Samuel Glade-Wright, Brisbane, Queensland (AU)

(21) Appl. No.: 16/971,784

(22) PCT Filed: Feb. 23, 2019
(86) PCT No.: PCT/AU2019/050155

§ 371 Date: Aug. 21, 2020

(30) Foreign Application Priority Data
Feb. 23, 2018 (AU) 2018900590

(51) Int. Cl. G06Q 30/06; G06Q 30/02; G07C 11/00; G06Q 20/08; G06Q 50/18; G06Q 20/20; G06K 7/14

(52) U.S. Cl. CPC G06Q 30/0613; G06Q 30/0201; G07C 11/00; G06Q 30/0633; G06Q 20/085; G01S 19/42; G06Q 20/202; G06Q 30/0605; G06K 7/1417; G07C 2011/04; G06Q 30/0202; G06Q 50/188

(57) ABSTRACT

The invention relates to a system, means and method for managing a queue of patrons seeking access to a product offering, for example entry to a private venue for which a ticket is required, or purchase of a product offered online of which a limited supply is available. A user of a system that implements the invention will receive priority attention when wishing, in the role of a patron, to order a product offering (be it a good or a service), on-demand and across varied platforms, which may include, in-store, online and telephony platforms. An advantage of the invention is that data generated from interactions with patrons can be recorded, stored and shared and may be used to provide real-time information and feedback to system users in the role of product offerors. The information may relate to queue place allocation, ranking and wait time in a queue being managed using the invention.

### FIELD OF INVENTION

This invention relates to apparatus for and a method of providing purchasers, interested in a product-offering, with options for queuing to acquire the offering.

### BACKGROUND TO THE INVENTION

Day to day global business operations are not static, they fluctuate constantly, with high levels of uncertainty and external forces at work. Ebbs and flows, consumer demand, peak and off-peak times are simply an accepted part of everyday business.

A significant source of frustration for customers or purchasers and business owners concerns the time it may take to receive or render a service. With time being seen as a valued commodity, purchasers requiring goods and services are likely to have experienced at first hand the impracticalities of excessive queues and wait times. More often than not, these experiences are negative for the purchaser and business provider alike. A loss of business may result.

It can sometimes be difficult to predict when busy queues will form, increasing wait times to unsatisfactory levels: They often emerge from nowhere and across countless industries. The impact on those in a queue and on those providing the product offering being sought are many and varied, from irritability and increased stress to unquantifiable losses in sales and revenue, let alone of goodwill for the business concerned. Altercations between staff and customers and between queueing customers themselves may flare up and even lead to violent confrontation. Ameliorating conditions leading to conflict is an ongoing challenge for many otherwise successful businesses.

Some examples of when excessive queues and wait times may occur include: new store opening, product launch, peak foot-traffic times i.e. lunch-time in a food court, events and festivals, baggage check-in at airports, concierge, nightclubs and bars, restaurants and café s, purchaser service industries (banks, transport and government departments).

In addition, there are many instances where purchasers must endure excessive wait times for goods and services they have ordered online. For example, receiving a product that arrives days or even weeks later than the order date.

Moreover, services that have been ordered online such as tickets to a sporting event, in many instances require the purchaser to join extensive queues to gain entry into the venue and, once inside, having to endure drawn-out queues for food and beverage purchases.

Physical queues and online ordering are not the only issues that cause annoyance to customers and businesses. Extended wait times are common in telephony, for example, attempting to call a customer service centre, such as telecommunications providers, electricity suppliers, transport departments and being placed on hold for excessive periods of time.

There is perceived a need for a dedicated system for a centralized priority service platform across many industries, that will address these issues and assist in reducing queues and wait times, whilst achieving improved purchaser and business satisfaction. Giving purchasers the freedom to purchase a priority user experience across different platforms on-demand, not only empowers purchasers to gain control over the timely provision of goods and services, but also makes businesses more accountable to their customers.

Airlines have attempted to alleviate queuing issues at airport check-in counters by providing for online check-in facilities and by providing for different classes of travel, distinguished by price and service levels on board. Customers who pay in advance for first or business class seats, beds, capsules, pods or suites receive segregated check-in queues, which are almost inevitably shorter than queues for economy travellers. In the context of airline check-in queues, the purchaser or customer is paying ultimately for the onboard service rather than the queuing experience (although there may be exceptions).

In the context of cinema queuing, where there is no differentiation in seating, customers who pre-purchase tickets are entitled to a collect them via a dedicated queue, which generally is shorter than the queue for those who have not pre-purchased.

U.S. Pat. No. 7,778,937 (to Ferrara et al) provides for automatically predicting customer wait times for receiving services, using current and historical service data.

An aspect of telephonic queuing when there is a high volume of calls to be handled is described in published patent application US 2003/0195753. Incoming calls are managed by a voice response unit (VRU). Each customer, or a selection of customers, may be offered the priority service, for example when wait times exceed a threshold. This disclosure does not deal with the purchasing of services or goods, being limited to the delivery of assistance.

Korean patent application publication number 1020140071246 discloses a digital prepayment solution that uses hybrid near field communications and short message services by which a data centre or hub communicates with a smartphone and with a point-of-sale computer device, as well as servers at sales facilities registered as part of the system. Customer queuing is mentioned, but there is no suggestion of a priority- or price-differentiated service or queuing option.

US application publication 2003/0102956 provides a queue control system which allocates a queue position to a patron, reserving a place for that patron without requiring the patron's physical presence in the queue until shortly before boarding the attraction or attending the event being queued for. It addresses the challenge that an unforeseen delay in presenting the attraction may lead to the possibility of patrons within a virtual queue taking all of the available spaces on the attraction, thus causing the real or physical queue to come to a halt. It does this by maintaining a single queue line for an attraction, within which the patrons may be either physically or virtually present, the patrons being ranked in a single ranking. When the time comes to access the attraction, ranked patrons who were absent from the physical queue are permitted to present themselves at a separate joining location, where they queue to be admitted to the main queue, as it were, according to their rank compared with that of the physical queue. This avoids absent patrons pushing past customers in the physical queue. Essentially, the system holds a place in a queue for someone who prefers to be elsewhere than standing doing nothing in line. For this privilege he pays a premium (“pay and go away”). It does not advance a patron up the ranking in exchange for their paying a higher price.

According to US patent application publication 2014/0207626, a registered user of the system there proposed may purchase access to their preferred position in a queue at a going, real-time, market-based variable price. The user interface may be provided through a mobile electronic device—for example a smartphone. A user waiting in line at a nightclub may, through the user interface provided in his smartphone, purchase the ability to skip the line and enter the nightclub immediately. This publication therefore provides for an existing queue to be skipped altogether, with the user being catapulted to the front or some other selected position, for example to be with friends ahead in the queue. A drawback perceived in this kind of solution is that other patrons waiting in the queue are likely to become disgruntled on seeing others being inserted into the queue in front of them. This may lead to human conflict, especially in situations where some patrons may have become at least partially intoxicated before joining the queue.

U.S. Pat. No. 9,892,371 provides means for incentivizing patrons to choose not to queue for an offering for which there is a long waiting queue, but to choose to queue for a second, different offering, for which there is a much shorter queue, or no queue at all. The patron therefore is induced to switch queues from a long or crowded queue to a second, less crowded queue for a different product offering. The incentive may be a discount or special offer. The second queue is one that already exists and does not need to be established. To entice some of the many at one queue to try another, where there are few, a notification is broadcast to incentivise the switch.

Application publication US 2012/0116789 discloses the existence of “normal” and “VIP” lines and communications devices in a system set up to allow a patron to choose between them for a premium. It does not disclose that a completely new queue may be established ad hoc. Instead, it describes that VIP lines already exist for attractions and that customers get offered places therein at a premium. A drawback of having already established VIP lines is that it removes operational flexibility and responsiveness to developing situations, which do not suit a fluid environment such a queue of impatient, intoxicated customers outside a nightclub.

### OBJECTS OF THE INVENTION

It is an object of this invention to address limitations of the prior art and, in doing so, to provide an automated system that expeditiously processes purchasers waiting for a product offering, via a priority-attention queue at a price. The product may be a good or a service. The automated system is embodied in an interface between customer and vendor made available for example by means of a web portal, as will be elaborated on below.

The preceding discussion of the background to the invention is intended to facilitate an understanding of the present invention. However, it should be appreciated that the discussion is not an acknowledgement or admission that any of the material referred to was part of the common general knowledge in Australia or elsewhere as at the priority date of the present application.

Further, and unless the context clearly requires otherwise, throughout the description and the claims, the words ‘comprise’, ‘comprising’, and the like are to be construed in an inclusive sense—that is, in the sense of “including, but not being limited to”—as opposed to an exclusive or exhaustive sense—that is, meaning “including this and nothing else”.

### SUMMARY OF INVENTION

The invention provides a system that allows a user thereof to receive priority attention when wishing, in the role of the purchaser, to order a product offering (be it a good or a service), on-demand and across varied platforms, which may include, but are not limited to, in-store, online and telephony platforms. In this specification, reference to “in-store” is intended to include not only a bricks-and-mortar shop, but any trading entity, including professional practices and other service providers that operate from physical premises. An advantage of the system is that data generated can be recorded, stored and shared and may be used to provide real-time information and feedback to system users. The information may relate to queue place allocation, ranking and wait time, historical and prospective, without being construed as limited thereto.

It is important to bear in mind that an offering contemplated in this invention may be one that results in delivery of a good; it may also result in the delivery of a service per se. The priority attention being contemplated herein is the act of serving a purchaser, that is, attending to a request from a purchaser of an enterprise for a product offering being offered by that enterprise.

Thus, in a first aspect of the invention, there is provided a system for providing customer service to purchasers queuing to access a product offering, the system comprising:
a. a first location defining a start for a first queue joinable for receiving the product offering at a first price;
b. a second location defining a start of an alternative queue joinable for receiving said product offering at an alternative price differing from the first price; and
c. queue establishment means comprising a digital communications interface operably configured for:
   i. receiving a queue-establishment stimulus for creation of an alternative queue,
   ii. establishing the alternative queue, and
   iii. digitally communicating to potential purchasers notification of the establishment and location of the alternative queue.

The stimulus may be inputted by a vendor of the product offering, or by a purchaser seeking access to the offering. Alternatively, the stimulus may be triggered automatically by the satisfying of a queue-establishment criterion or parameter.

Preferably, using the means for establishing the alternative queue, directions or stipulations may be issued by the vendor of a product offering, relating for example to customer limits, descriptions of the product offering, and the like.

In a preferred form of the invention, the customer service system comprises data processing means operably programmed with executable program steps causing it to:
a. collect and process data relating to the first queue;
b. apply a queue establishment criterion to the data and, on the basis of said data meeting the criterion, establish the alternative queue.

Preferably, the system is further configured for offering a purchaser a place in the alternative queue at the set value.

In a further preferred form of the invention, the data processing means is programmed to request, on a prioritized basis, an order in respect of the product offering from a purchaser in the alternative queue. The data processing means thereby causes alteration in the options shown to the purchaser on the portal represented on the screen interface of the purchaser's device to reflect the offer and prompts for eliciting the purchaser's order.

The customer service system is preferably further configured for allowing online negotiation of the second price value between said purchaser and a vendor of the product offering.

In an embodiment, the customer service system is configured for receiving a value for the second price inputted by a purchaser.

Preferably, the system is configured for receiving an input from the vendor, responsive to the second price value inputted by the purchaser.

In a further preferred form of the invention, the customer service system comprises means for inputting a negative value for the first price.

In a still further preferred form of the invention, the first queue is accessible via an internet website.

The alternative queue location may be identified by means of global positioning co-ordinates communicated to a purchaser who has made an input in relation to its establishment or second price.

In an embodiment, the first queue location is at a customer service area defined by the vendor.

The alternative queue location may be adjacent the first queue location. It may have a virtual location. The location may also be temporary and the queue may be relocatable. Relocation may be by way of communicating updated co-ordinates to purchasers interested in the establishment of the alternative queue.

In a preferred embodiment, the system comprises digital communication means for providing a vendor of the product offering with data pertaining to the first queue.

The system preferably comprises digital communication means for providing the vendor with comparative data pertaining to the first and alternative queues.

By way of example, the comparative data may relate to the requesting purchaser's rank in the alternative queue in virtual real time.

The system may further comprise data processing means programmed to request, on a prioritized basis, an order in respect of the product offering from a purchaser in the alternative queue. That is, the purchaser in the alternative queue is prioritized above a purchaser in the first queue.

In a second aspect, the invention provides a computer-implementable management system for managing a queue of purchasers of a product offering, the system comprising a temporarily locatable point of sale for a product offering, the point of sale being defined by a system computer configured to function as a mobile point of sale and for communicating with at least one group of remote computerised devices, a set location of a first queue for attendance by purchasers equipped with said remote devices and seeking access to the product offering at a first price; and executable program means for the system computer, or a remote device in communication with it, to initiate creation of an alternative queue at a temporary point of sale defined by the location of the system computer or remote device, when spaced from the first queue, at which point of sale the product offering is offered at a second price that differs from the first price.

Preferably, initiation of creation of the alternative queue by a remote device comprises dispatch of a wirelessly communicated request from a remote device to the system computer or remote device associated with the vendor, for creation of said alternative queue.

In a preferred embodiment, the system computer or remote device associated with the vendor is configured to issue an invitation to join the alternative queue to a limited number of remote devices in the first group.

According to a third aspect of the invention, there is provided a computer-implementable method of purchaser queue management, comprising providing a computer running executable instructions causing it to:
a. Offer access to a product offering available for purchase online at a first price;
b. Establish a first queue for joining by a prospective purchaser seeking access to said product offering at the first price;
c. Monitor said first queue for gathering queue-related data;
d. Based on an establishment criterion being met according to the data, establish an alternative queue for joining at a price differing from the first price for a prospective purchaser to receive priority service in respect of said offering;
e. Receive and process a request from a prospective purchaser to join the alternative queue; and
f. Communicate queue status data to the purchaser in virtual real time.

The method preferably comprises the step of causing the computer to evaluate the request against a predetermined joining criterion.

The joining criterion preferably relates to payment of the joining price by the requesting purchaser for being allocated a place in the alternative queue.

Preferably, the method includes the step of defining, by means of the computer, a temporary point of sale which marks the start of the alternative queue.

In a preferred form of the invention, the method includes providing purchaser interface means for offering a place in the alternative queue to the purchaser and being operable by the purchaser, to accept the place.

Further preferably, the computer is programmed to request an order from a purchaser in the alternative queue on a prioritized basis over a purchaser in the first queue.

The method preferably includes providing purchaser interface means comprising a visual display on a mobile communications device operable by the purchaser.

According to a fourth aspect of the invention, there is provided a system for implementing a method of prioritizing the processing of a purchaser's order, the system comprising:
a. A website comprising an interface configured for receiving online orders placed for a product offering;
b. An order-receiving device configured for receiving orders submitted via the website;
c. A digital order electronically generated for submission to the order-receiving device;
d. An order-submitting purchaser device, operable by a purchaser and programmed for generating and submitting said order;
e. An allocation device in communication with the order-receiving device, the allocation device being programmed to:
   i. create an online queue of orders for said product offering,
   ii. allocate the order a place in said queue of orders,
   iii. cause feedback to be sent to the purchaser device comprising data concerning said queue and place; and
   iv. receive and process a purchaser-generated request for allocating the order a place in an alternative, prioritized queue yet to be created for the product offering
placement in the alternative queue being conditional on the purchaser's agreeing to pay a premium for being allocated a place therein.

In the system, the purchaser-generated request may be generated by the purchaser at purchaser's instance.

Alternatively, the purchaser-generated request may be generated by the purchaser in response to an offer of a place in the alternative queue.

In a preferred embodiment, the offer is issued as a result of programming of the allocation device to respond to data relating to the first queue.

The data relating to the first queue preferably comprises one or more of: numbers of orders in said first queue, order processing time estimated, inventory levels, order processing capacity and resources.

According to a fifth aspect of the invention, there is provided a service interface between communications devices operated by parties to a prospective transaction, the parties being a vendor offering a product offering and a purchaser seeking the product offering, the devices including a purchaser-operated device and a vendor-operated device, the interface being:
a. configured for receiving orders placed via the purchaser-operated device
b. adapted for allowing purchaser or vendor, through their respective device, to:
   i. propose a priority queue for attending to orders for the product offering on a prioritized basis, and
   ii. propose a price payable for being in said priority queue,
c. adapted so that, if acceptance is signified by means of a device that is not the price-proposing device, the interface signifies via the purchaser-operated device that:
   i. a priority queue has been established,
   ii. the purchaser-operated device has been assigned to the queue, and
d. configured for outputting to the purchaser-operated device a wait-time duration remaining, before an order from the purchaser-operated device will be processed.

The interface may preferably comprise a telephone connection, or an online website, or a touchscreen display on a communications device, or desktop computer running an app from a service provider or accessing an online vendor portal.

The communications device may be a mobile device such as a tablet computer, smartphone handset, notebook computer, communications-enabled card, or wearable communications apparel such as a smart watch, computerised armband or computerised headgear, or implantable communications-enabled device, as known in the art.

The service seeker may be considered a purchaser of a product-offering of the enterprise of the service provider.

In a preferred form of the invention, the interface is periodically updated for communicating to the purchaser device the queue status and its position therein. Preferably, the interface is updated with respect to wait-time in the priority queue compared with wait-time predicted in an alternative queue.

In a sixth aspect of the invention, there is provided an automated method of servicing purchaser requests for a product offering, the method comprising the steps of:
a. Providing a network of digitally connectable communication-enabled devices, the devices including a computer, configured and programmed for operation by a vendor of a product offering, and at least one purchaser-operated communications device;
b. Allowing the vendor-operated computer, running software thereon, to set a price at which a purchaser associated with the purchaser-operated device will receive prioritized attention for placing an order for said product offering;
c. Causing the purchaser-operated device to receive notification of an option to join a prioritized attention-receiving queue, for receiving the prioritized attention, and a fee for being placed in said prioritized queue;
d. Allowing the purchaser, via the purchaser-operated device, to communicate their election to join said queue at said fee; and
e. Responsive to said election, causing the vendor-operated computer to allocate a place in the queue to the purchaser-operated device and to communicate said place and a queue status report to the purchaser-operated device.

In a preferred form of the invention, the method includes the step of allowing a first of the networked purchaser-operated devices to request prioritized attention for placing and processing of an order for the product offering.

According to the method, the first of the networked purchaser-operated devices may request priority attention at the user's own instance, or responsive to an offer issued from a computer associated with the vendor.

Preferably, the method includes causing the vendor to provide updated queue status reports to the purchaser, via the purchaser-operated device, at intervals. The intervals may be selected by the vendor, operating the vendor computer, or by the customer operating the purchaser device.

In a seventh aspect of the invention, there is provided an alternative queuing system comprising
a. a first queue of purchasers seeking a product offering;
b. a software interface operatively displayable on a mobile device operable by a user seeking priority attention for placing an order for the product offering,
c. the interface displaying an offer of joining an alternative queue to the first queue for the product offering at a price set by an offeror of the offering.

In an embodiment of the system, the interface displays an invitation to the vendor of the product offering, inviting from the vendor, input of a discretionary amount, defining a price payable by a purchaser wishing to join the alternative queue for priority service in respect of the product offering.

The system is preferably programmed so that, conditional on an offer price being set and recorded in the system, the system prompts input from the purchaser device user whether to accept a place in the alternative queue.

Further preferably, the system includes executable program instructions effective to cause the system to respond to acceptance of a place in the alternative queue, by assigning a place in said queue to the operator of the purchaser device.

The system preferably is programmed to cause to be displayed on the purchaser-operated device a report, comprising queue status and the user's place ranking therein.

The price payable preferably represents a discretionary price point settable by the vendor, with or without guidance from an algorithm in the software for use in calculating and recommending a selectable price, based on pricing predetermined parameters.

In an embodiment, the system is operatively programmed for allowing the purchaser to see their place ranking, even if they are not physically standing in the alternative queue.

In further embodiments, the system may include one or more of the following:
Means for establishing, on demand, a priority service queue;
A pricing system operable exclusively by the vendor at their discretion;
Means for informing a purchaser visually or by audible communication, when and where a priority queue exists; and whether it is available for joining;
Real-time feedback giving means, whereby a queuing purchaser can track where they are in the queue in real time;
Means enabling user to assess average wait time and queue price, prior to joining the priority queue;
Display and data recording means, including real-time and stored information;
Cross-platform functionality-giving means, deriving from trans-platform integrating means, which may include a telephony platform, or an online trading platform or a bricks-and-mortar-type store.

Preferably, the system includes means for the user to cancel prioritized service at any time prior to transaction.

The system preferably includes means for the vendor user to activate and deactivate the queue at any time (save for those who have already paid to be in the priority queue).

In a preferred embodiment, the system is cashless, meaning that users effect payment for entering the queue by online means. In preferred embodiments, payment is made at the time of payment for a product offering ordered. Preferably, payment is made at point of sale for the offering.

According to an eighth aspect of the invention there is provided an automated system for managing purchaser queuing for a product offering, the system comprising:
a. A network of digital communication-enabled devices, the devices including a computer configured and programmed for operation by a vendor of a product, and at least one purchaser-operated communications device;
b. Software running on the vendor device rendering said device operable for the vendor to set a price for a purchaser to receive a prioritized attention for placing an order for said product;
c. The purchaser-operated communications device configured to receive, and communicate to the purchaser user, notification of an option to join a priority-receiving queue for receiving the prioritized attention, and a joining fee;
d. The purchaser-operated communications device being programmed to for enabling the purchaser to communicate their election to join said queue; and
e. Responsive to said election, the vendor device being programmed to communicate a queue status report to the purchaser device.

### BRIEF DESCRIPTION OF DRAWINGS

In order that the invention may be readily understood, and put into practical effect, reference will now be made to the accompanying figures. Thus:

FIG. 1 is a process diagram of a preferred embodiment of the system of this invention.

FIG. 2 is a process diagram of the system of FIG. 1 adapted to the queuing of purchasers seeking an online store, according to the invention.

FIG. 3 shows illustrative screen shots displayed on a purchaser device when participating in the method and system of the invention in FIG. 2.

FIG. 4 is a process flow diagram of the invention applied, in a further embodiment, to a service offered via telephone.

FIG. 5 illustrates an alternative ordering process using the platform of the invention.

FIG. 6 illustrates an interface of the invention from the vendor perspective and the purchaser perspective in turn.

### DETAILED DESCRIPTION OF AN EMBODIMENT OF THE INVENTION

This invention provides a practical and consolidated solution to excessive queues and wait times for purchasers seeking service, thereby improving overall customer experience in relation to the business concerned, whilst ameliorating a common global problem. The system of the invention utilizes software running across integrated platforms to enable on-demand priority service queues and wait times. The system can be operated anywhere and at any time, whether in a bricks-and-mortar store, on an online trading platform or using a telephony-based service. The system may be utilized by running system-specific software, as described below, on compatible hardware, which may be contained within a portable communications-enabled device, i.e. internet-enabled and/or short range wireless protocol device, including without limitation a smartphone, wearable apparel, a smart watch, fitness monitoring device, tablet, notebook computer, and the like. A desktop computer may also be utilised.

In this specification, a vendor-operated device is to be understood to refer to a device operated by an authorised device user, such as an employee of a vendor organisation or a proprietor of vendor business. The employees may be assigned different levels of authorisation according to role, permitting them to perform different functions using their allocated device in relation to the interface. For example, a night club-operating organisation may have the following roles defined for employees, in descending level of authorisation: An administrator, who manages the overall application or portal; a venue manager who manages the venue through the portal, being able to view and update information pertaining to the venue, including patron numbers, staffing levels and other statistics; a shift manager who manages use of the application or portal during a set shift period and is authorised to alter pricing, queue availability and view ticket purchases; and door staff, who use the application client side to scan QR codes or other entry authorisation means assigned to individual tickets purchased by patrons.

The interface of the invention is configurable for an authorised vendor-operated device to have exclusive permission to set a ‘discretionary price point’ for all on-site or in-store queues and for either the vendor or the user of the seeker device to set off-site or out-of-store queues and wait times. This means that if a seeker (purchaser) device is operated to request the ‘off-site/out-of-store’ services of a vendor registered on the system, they will have the option to see if the vendor already has in place a priority service and that it is available for use. If so, the user can pay the service fee stipulated for priority service or, alternatively, have the option to ‘make an offer’ that is over and above the price already stipulated. This works in favour of the seeker, who will be elevated in the queue for a faster service—whether in-store, or by way of call-out.

Alternatively, if there were no off-site price stipulated by the vendor, the purchaser is still able to ‘make an offer’ to any participating businesses for consideration of faster service, by responding to a prompt to enter a price. Before a user is registered on the system, the user is given the options to elect to receive push notifications, allow biometric scanning for an extra level of security when making purchases, and allow location services for finding a venue that operates the system of the invention.

Implementation of the invention will now be described with reference to the drawings.

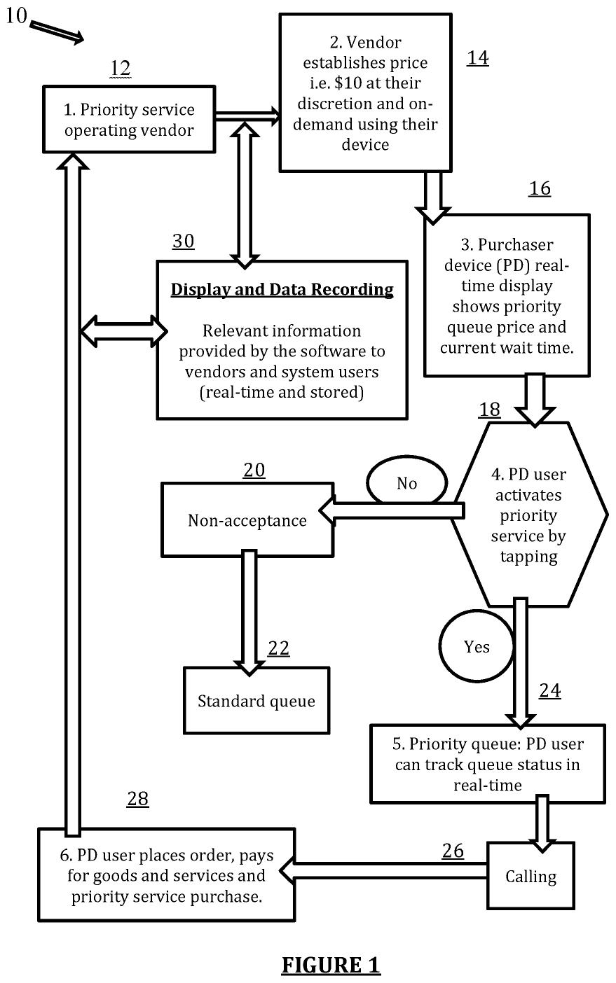

Referring to FIG. 1, there is depicted a vendor 12, operating a priority queuing service at a premium. The premium in this embodiment is a sum of money, but in other embodiments it may take the form of a different obligation or indebtedness on the part of the queuer to the vendor. By way of example, the obligation may be expressed in a number of loyalty programme points.

The vendor sets up the system for use at his premises by way of downloading software from an app store or other supply platform, or by registering with a content management system (CMS) delivered through website portal made available by the system provider. When registered on the portal, the vendor is able to log in and perform the queue management functions to be described below. The vendor displays a notice at the premises alerting passers-by that the business concerned operates the queue-handling software of the invention. Notification may also be performed by issuing broadcasts to potential customers operating purchaser devices within a given range of the premises using a short-range wireless communications protocol, for example the “Bluetooth” standard, or via social media or by any other suitable means. Depending on the relative global positioning co-ordinates of a purchaser device and the vendor premises, the vendor system may be programmed to send an alert to the purchaser device using a short message service (SMS) system. The user of the purchaser device will in this way be alerted of the availability of a vendor that offers a priority queuing facility. Operating instructions inform the vendor of the need to distinguish a first standard queue from an alternative second, premium or priority queue.

On running the software on board, or via accessing the system provider's portal, the vendor's device prompts the vendor to input a price for a place in an alternative, premium queue for the services being offered. The price is set at the vendor's sole discretion 14—for example by the vendor's personnel in the role of shift manager. However, the vendor may be presented with the choice of having the system software automatically propose a price, based on data gathered according to prearranged parameters and determination criteria. For example, the criteria or parameters may include day of the week, date in the year, seasonal data such as weather conditions, economic factors and micro-factors such as the service time and number of patrons already queuing, as well as a maximum queue length allowable.

The vendor may at his own discretion initiate an alternative queue. This may be in response to an increasing length of a first or principal queue for which no premium is payable. He may then initiate the alternative queue by executing system program instructions from his computer device. The system may also use queue data obtained by sensors, or inputted by the vendor, to initiate an alternative queue or notify the vendor that initiation of such a queue is appropriate in the circumstance. The vendor may then respond to an on-screen prompt and decline to do so, or may accept the recommendation and input a premium to be added to the standard price and charged for purchaser devices to join the priority queue.

A purchaser, being a prospective patron and user of a smart phone handset, on entering the vicinity of the vendor's establishment, should receive an alert and see displayed on the device screen the notice to the effect that the establishment subscribes to the system of the invention and that the purchaser may choose to log on to the system portal via a given URL, or by downloading an app from an app store and then running it to gain access. When login has occurred, identifying the purchaser device and purchaser to the system, the system software displays on the purchaser's device a wait time that the user should anticipate, should the user elect to pay for a place in the vendor's priority queue, and the price for joining it 16. The wait time may be an historical wait time or may be the current wait time as calculated on the basis of the most recently served purchasers—for example five purchasers, or fewer, if the vendor's business has just recently opened its door for the day and has not yet served five purchasers.

The user of the purchaser device is directed by way of a screen display, or an audible instruction, that a priority queue is available at the previously displayed premium, and that the purchaser should choose to use it 18. The purchaser may be offered the option of delaying his or her decision for a “snooze” period, before being offered it again. The priority queue may be temporarily established and its proposed temporary location may be communicated by the purchaser choosing to use it, preferably after the purchaser has made the election. This is to avoid attendance at the temporary queue site by patrons not willing to pay for a place therein.

In an embodiment, the vendor is permitted to elect to set the software settings to allow the purchaser who elects to “snooze” to retain the previous position offered, or to be sent to the back of the priority queue, should he take up the premium queue offer after a “snooze” delay has expired.

If the purchaser declines the offer or fails to provide input after a set period, the system software executes instructions 20 send a push notification to display on the purchaser device screen a confirmation notice that the offer has been declined and that the standard queue awaits, should the purchaser still remain desirous of receiving the vendor's product 22. If the purchaser accepts the offer—done in this non-limiting example by his tapping his display screen in the appropriate place offered—the purchaser is entered in the priority queue via his device 24. The software causes information to be displayed on the purchaser's device screen showing real time data, for example, the purchaser's numerical rank or place in the queue, the time estimated before service and a timer, which is updated at intervals or in real time, as earlier purchasers are attended to. This information enables the purchaser to do alternative things if he should choose not to wait in line at the premises. The vendor may program rules into the system to deal with a situation such as the absence of a priority queue purchaser when his device is “called” 26. Calling may be by means of an automated telephone call to the device, or a text message, email, social media alert and the like and may be elected at the receiver's instance.

The purchaser proceeds to the service counter where he identifies himself as having joined the priority queue. This is accomplished by displaying a code, such as a QR code, a PIN number or an order number issued by the system on joining the priority queue, or other suitable identification means. The purchaser places his order and pays for the order, to which the priority queue premium is added. Payment is preferably by means of a cashless system using the purchaser's smartphone, according to known methods. The use of cash is anticipated to slow down transactions, as well as increase security risk. In another embodiment, the purchaser may place and pay for their entire order, along with their place in the priority service queue prior to being called.

Throughout the process 10, selected data pertaining to purchasers, interactions and transactions, as well as to process factors such as passage of time and transaction times per purchaser, is recorded 30. As indicated, some of the data is used to provide service information to purchasers for managing their expectations. The vendor receives data that can be used for process improvement within the business. The system operator is able to collect data pertaining to purchaser purchases and purchasing habits or use in marketing and future advertising, as is well known in the art. As the purchaser is processed, the data gathered is processed in the system processor according to the software instructions for informing waiting purchasers with updated wait times. The vendor may make use of the data for determining premium pricing changes. The software may comprise an algorithm to suggest pricing changes and price points and levels to the vendor, based on the throughput of transactions in the current business day, or using historical data and the number of purchasers in the priority queue already, and/or the number of purchasers who have declined priority queuing.

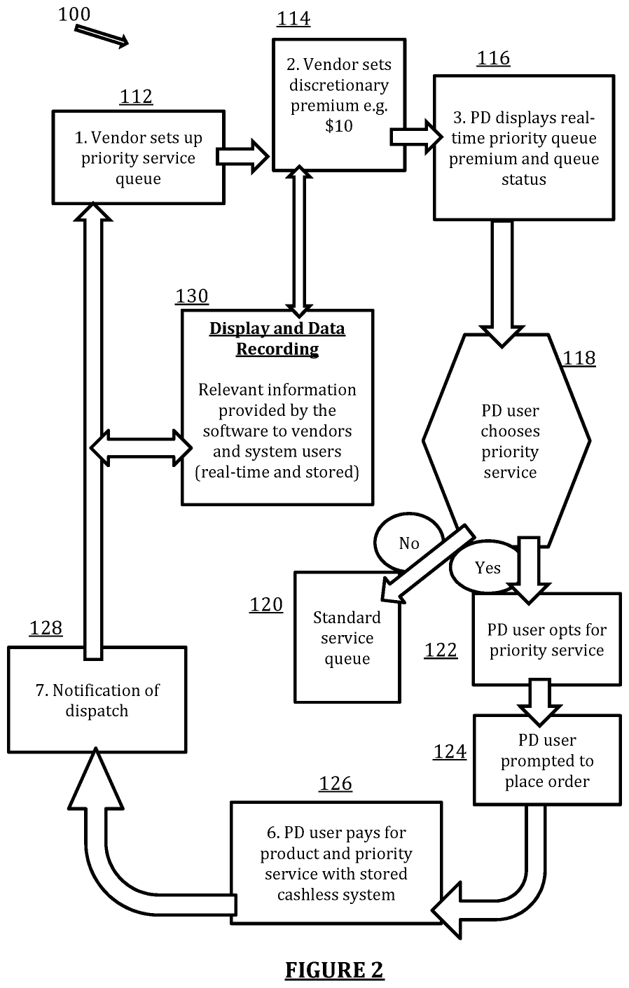

Turning to FIG. 2, an embodiment of the invention is illustrated in which the process, generally indicated by the numeral 100, is shown in the context of an online vendor. It proceeds in much the same way as described in relation to FIG. 1, with a vendor 112 operating a priority queuing service at a premium. The premium in this embodiment is a sum of money, but may take the form of a different obligation or indebtedness on the part of the queuing purchaser to the vendor.

The vendor sets up the system for use on its computer devices (e.g. desktop, laptop, notebook or tablet and the like) by way of downloading software from an app store or other supply platform. It displays a notice on its trading website alerting site visitors that its business operates the queue handling software of the invention. The vendor is also given a facility via a wizard interface for alerting devices of prospective purchasers that the system of the invention is in place at his establishment. As previously mentioned, the purchaser may receive the alert on the basis of geo-proximity comparison data via a short-range wireless broadcast or SMS message. Operating instructions executed by the computer processor inform the vendor of the need to distinguish a first standard queue from a second, premium or priority queue and walk the vendor through the necessary set-up steps for defining the queues. There may be two or more queues, each enjoying a differing priority level and/or a different price premium. The vendor may set the software settings to transmit comparative or other data concerning any such queue or queues to the purchaser device.

On running the software, the vendor's device prompts the vendor to input a price for a place in a premium queue for the services being offered. The price is set at the vendor's sole discretion 114, with or without prompt of price proposals from the system software, based on data gathered according to prearranged parameters as discussed in relation to FIG. 1. In this embodiment, different parameters may apply, in addition to day of the week, date in the year, seasonal data economic factors and micro-factors such as the service time and number of patrons already queuing. An example of an additional factor is inventory level or resource capacity for rendering a service being ordered online.

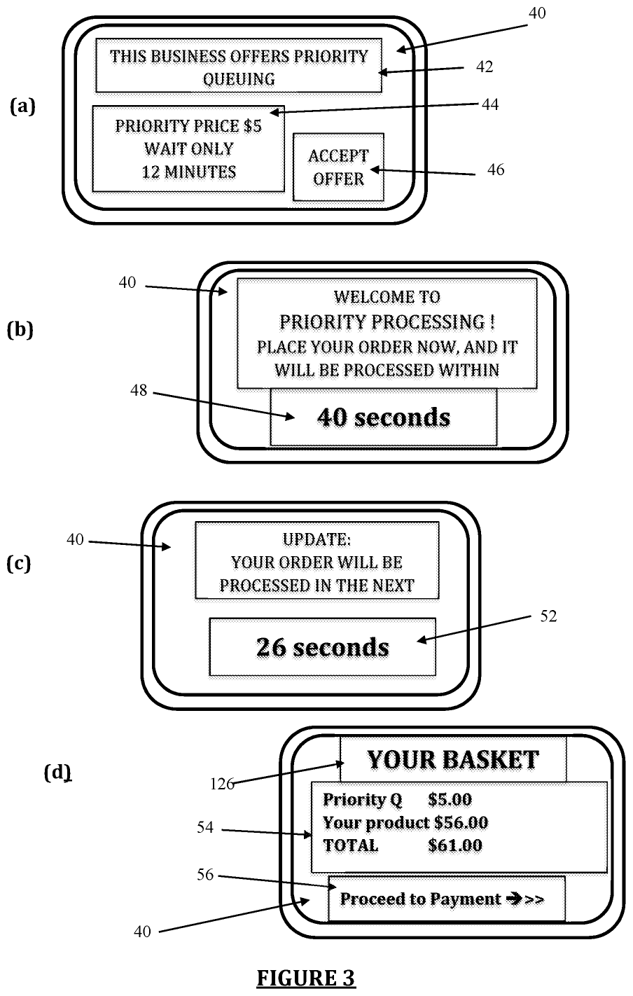

A purchaser, being a user of an internet communications enabled device, in this example a smartphone handset display screen 40 (see FIG. 3 (a)), accessing the vendor's website, sees displayed notice 42 to the effect that the website provider subscribes to the system of the invention and that the purchaser may choose to join a priority service delivery queue for making their purchase 116. The website also displays the anticipated wait time current at the time and the premium payable for joining the priority queue 44. The wait time may be an historical wait time or may be the current wait time as calculated on the basis of the delivery times for a group of most recently served purchasers. Optionally, the user can be displayed the number of others in the general queue and/or the number in the priority queue. In an embodiment, the number of items remaining in an inventory, such as tickets to a concert, or seats on an airline flight is shown. The user is offered to join the priority queue 118 and is guided to an election button, displayed at 46.

If the user declines the priority offer 120, the system software executes instructions to display on the user's screen that the offer has been declined and that the standard queue awaits, should the purchaser still remain desirous of receiving the vendor's product.

If the user accepts the priority queue offer at the premium payable 122, the website software then guides the user through the ordering process 124, before progressing to the actual checkout step 126. The software causes information to be displayed on the purchaser's device screen showing real time data, for example, the purchaser's delivery time for service 48 (see FIG. 3 (b)) and a timer 52, which is updated at intervals as earlier purchasers are attended to (see FIG. 3(c)). The purchaser proceeds to the virtual checkout 126 (see FIG. 3(d)), where he sees displayed the order and the priority queue premium 54. By tapping zone 56, the purchaser proceeds to the payment interface, where the choice of using the purchaser's smartphone or a credit card, or other online payment portal are offered, according to known methods.

Notification is issued automatically when the product ordered is about to be dispatched. This may be by means of an automated telephone call to the device, or a text message, social media alert and the like and may be elected at the receiver's instance.

As in the embodiment of FIG. 1, throughout process 100, events are logged, and selected data pertaining to purchasers, interactions and transactions, as well as to process factors such as passage of time and transaction times per purchaser, are recorded 130.

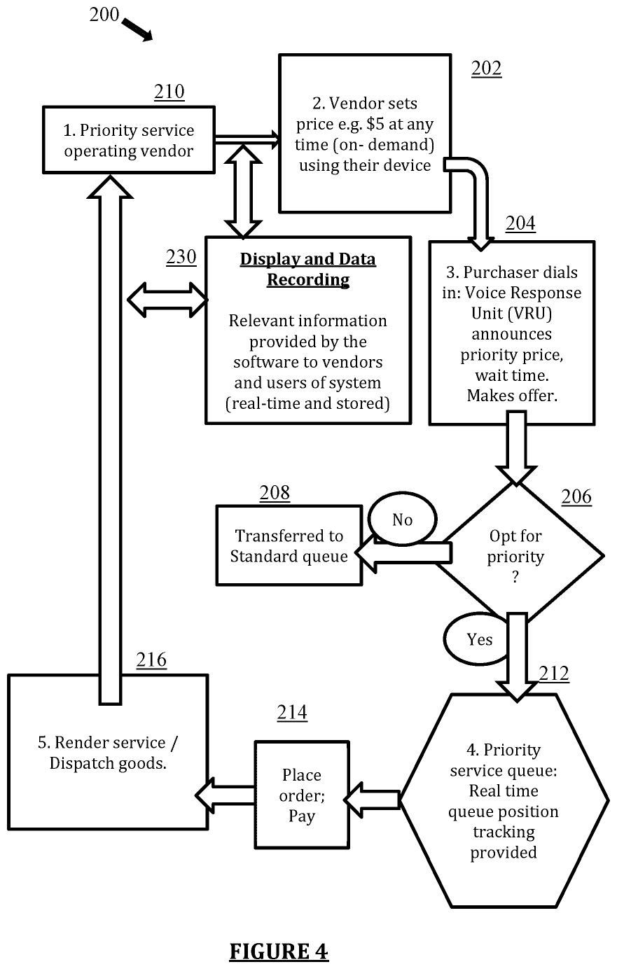

The embodiment illustrated in FIG. 4 concerns an ordering system 200 operated telephonically. As in the embodiments previously described, the vendor 210, operating a priority queue selection service according to the invention, sets a premium price for a premium queue that ensures purchasers electing that queue are attended to more promptly than those who decline to opt in 202. The operator of the vendor device is permitted to change the price at any time at their sole discretion. The changed price is not retrospective in regard to those already in the premium queue. However, the vendor software is configured so that the vendor may establish more than one non-standard queue, should demand warrant it. Hence there may at first be a first premium queue at say $5, but, as demand is sustained, or increases, the vendor may decide to establish a second, “super premium” queue at $12. New prospective purchasers may be offered only the $12 queue or to choose between both premium queues. Users already in the first established premium queue may be offered to upgrade to the super premium queue at a discount price, in which case they will join the end of the second premium queue. Alternatively, they are offered to jump to the head of the second premium queue if they pay the full difference between the first premium price and the price for the second premium queue. It will be appreciated that options of this nature may be offered in the embodiments described previously with reference to FIGS. 1 and 2.

On the user side, the user dialing in for the service offered by the vendor at 204 will receive an audible message from a programmed voice response unit (VRU), stating a premium queue price (or prices) on offer and the benefits to be gained, in terms of reduced waiting time, or a choice of “on-hold” music or audio entertainment. The purchaser taps the relevant button on the display of his smartphone or on the keypad of a conventional landline telephone handset 206.

Not accepting the offer transfers the user to the standard queue 208. Signalling acceptance causes the user to be transferred to the faster processing priority queue 212, where the user receives a queue status update, rendered audibly at short intervals, or by way of a visual display on the screen of the handset, subject to compatibility with the system.

The user reaches the start (or ‘head’) of the queue 214 and places his order. The order is processed and payment is effected for queue priority and goods/service, using a cashless method such as a smartphone payment app, or credit card information number entered via a keypad or vocally.

The purchased product (merchandise or a service) is delivered 216—for example a horoscope reading, a live consultation with a service agent, such as a patent attorney, medical clinician, financial adviser, chat-line host, a music recording, airline booking, theatre tickets and the like. Physical goods or services may be collected at a designated collection counter or venue—for example a massage service. Meanwhile, a log is compiled of actions and transactions in the queuing and trading process 230. Although a telephony-based system will provide faster access to a telephone representative of the vendor, it can also be used to pre-purchase a product for physical collection in-store, or for priority service delivery.

In a further embodiment, the system of the invention allows for the priority queue to be formed on a “first come, first served” basis for in-store product offering purchasers. That is, priority purchasers, although having agreed to a price for being in the second, or priority queue, will be ranked in the order in which they arrive at the location of the priority queue, joining at the tail. This contrasts with the system embodiment in which a customer is called on the basis of a timer signal.

According to a still further embodiment, the purchaser is enabled to subscribe to a web-based platform to which the vendor is but one of a plurality of product offeror subscribers. As a benefit the purchaser device receives automatic notifications when it enters the vicinity of a product offeror subscriber. The platform software will cause to be included in the notification a range of data concerning the vendor or vendors in that vicinity and the queue availability and status of each. The software instructions may include a setting for the purchaser device to be automatically entered into an available priority queue on entering the vicinity. An alert will be issued to the purchaser device informing the subscriber that he/she has been allocated a place in a queue should they wish to use it and inviting them to confirm or decline the offer. Payment will then be managed according to known methods, preferably at point of sale. If a user has elected to allow it, a push notification is sent to the user device at a set time before the offer is due to expire.

The system is further configurable for a prospective purchaser to place an order for the product offering using the software interface and accept a place allocation in the priority queue, after which the purchaser may either collect product in-store or have it delivered.

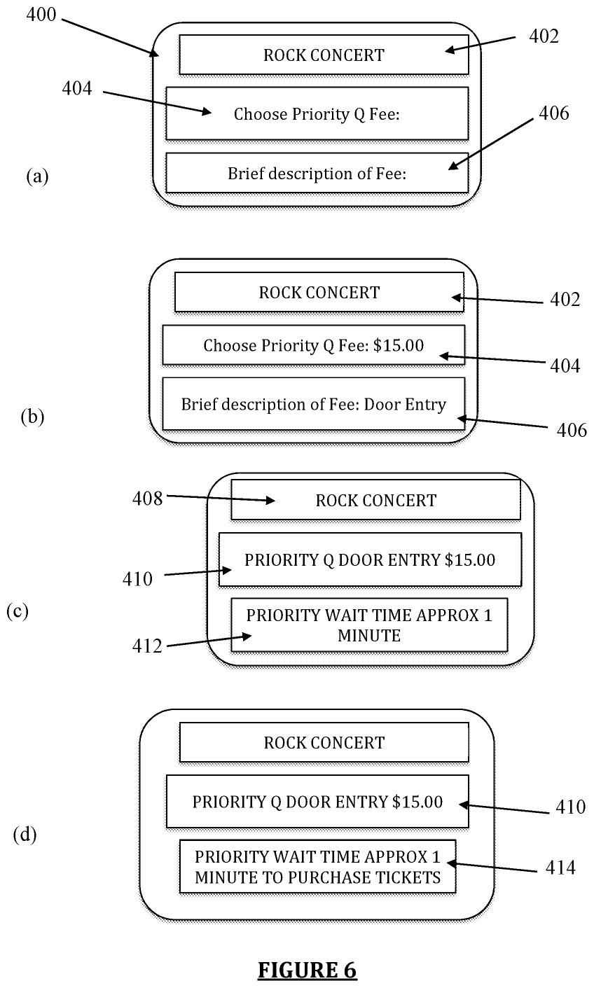

Referring to FIG. 5, a purchaser orders everyday consumables using an interactive display on their mobile telephone touchscreen 300. In FIG. 5(a), with Bluetooth® wireless communication enabled, when the telephone handset comes within range of a vendor venue that subscribe to the queuing management platform of the invention, the touchscreen displays a welcome message 302 and offers a button 304 for the user to tap to see a representation of nearby vendor venues. An additional button 306 provides quick access to the user's regular or favourite venues. The settings of the platform software on the user's handset may be manipulated to add or remove venues from the regular venues list or may be used to deactivate the regular venues facility temporarily or until manually reactivated.

The purchaser device user taps the ‘nearby venues’ and is displayed a list (not shown), from which a selection, “Charlie's Café” is made. This causes a display of the nature of FIG. 5(b) to be generated, a welcome message identifying the establishment contained in the header block 308, with categories of product offerings (“DRINKS”, “FOOD” and “OTHER”) in a row 310 below. In block 312 appears notice of the priority queue premium value payable. This will be added at checkout to the total payable for any items that may be ordered, should the user elect to make use of the priority offer. The user taps the relevant category for the goods being sought and is offered a menu from which he makes a selection from placement in a virtual shopping basket, according to known methods. He may continue shopping or proceed to checkout.

When the user has tapped that he intends to proceed to the virtual checkout counter, an order confirmation screen is displayed, as illustrated in FIG. 5(c). Box 314 lists the items ordered. The last item on the list is the price for the priority queuing option accepted by the user. This is included in the total block 318, which appears adjacent the bottom border of the screen. The device may be programmed to include any sales or value added tax according to local trading laws. Payment proceeds via the vendor's payment portal or may be made at the delivery point or other designated point of sale by any accepted means, including cash. The screen shown in FIG. 5 (d) alerts the user that the goods are being prepared for pick up and uses boxes 320 and 322 to indicate the expected waiting time until the goods will be ready for pick-up.

The operator of the imaginary “Charlie's Café” establishment, used as an example in FIG. 5, is given discretion in their program settings to take into account conditions in a primary, non-prioritized queue when establishing a alternative queue. This is left to their discretion.

It should be appreciated that the system can be configured to run the entire ordering function and priority queue service from and via the software interface. Consequently, a user of the purchaser device is enabled to place their order for a product via the app of the invention, via third party software (for example the product available under the brand name “Skip”), via other online methods known in the art, or alternatively they may elect to place an order ‘in person’ at a physical service point or point of sale, such as a vending machine or a manned counter.

By way of an alternative embodiment, the purchaser is able to secure priority service via an online voice or telephony-based platform and then make product choices either using the software (nominating whether to collect the product in-store or have it delivered) or separately from the software once they arrive at a destination to collect a product of choice. This could include pre-purchased priority concert tickets whereby the customer can enter the priority queue at the venue. It may also include a service, such as a mobile repair service for automobiles by means of which the service provider arrives to attend to the user's vehicle in preference to the vehicles of others whose owners have not paid the prioritization premium. It will be appreciated that the system of the invention therefore is operable not only to procure preferential attention for a customer, but also to assist the service provider in scheduling upcoming work.

It is within the scope of the invention for the system to be able to set up and manage additional queues, for example a first priority queue at a higher entry price than a second priority queue at a lower price than the first. Furthermore, the default, low priority queue may be advertised at a discount, or negative price, to induce punters to remain in it and perhaps increase the length thereof, by this device providing further inducement for others to elect to join a premium priority queue.

The system may be used in the sense of an immediate priority service whereby the subscribed purchaser accepts the price of a priority queue, and proceeds to an associated priority counter to place a cashless order separately from the system i.e. in-person. An example would be paying for priority queue service in-store and then placing an order at a counter. In all cases, the purchaser is not obtaining any different a product from the person electing to remain in the lower priority queue. The difference is that the prioritized purchaser receives priority attention. This is to be distinguished from the situation in which a purchaser pays for a premium service and receives the use of a priority queue, for example first class airline travel compared with business class and ‘economy’ class.

The option for pre-ordering and purchasing a product or service may also be included in the software interface, so that the purchaser will only need to collect or receive the product offering ordered without their having to order in person (as it will have been done via the system). In this instance they may need to show evidence of transaction approval.

For online processing, system embodiments may include using the system software for the transaction or using a portal which can be added to or interfaced with a vendor website (much like the “paypass”™ facility or other credit card payment method) to conduct the transaction. The system software is integrated with application programming interfaces (APIs) to ensure flow to and from third party platforms for achieving invention outcomes. For example the API known as STRIPE (see https://stripe.com.au) provides online payment processing for receiving customer payments; Google Maps and Apple Maps are the APIs used for plotting venue locations on a user interface within the system for displaying on purchaser devices; emails, including confirmation emails, forgotten password resetting emails and marketing emails are processed using the API known under the brand “MAILGUN” (See https://documentation.mailgun.com/en).

In a still further embodiment, once the purchaser has subscribed to the system, they may be afforded the facility simply to make use of priority counters offered by subscribing vendors at their leisure, for example by simply approaching the relevant priority counter, expecting to be served, or by joining any priority queue that may have formed. This may be accomplished without the prospective purchaser having to tap their device to indicate their presence of intention to enter into a transaction. The time taken for service may rely on wireless communication being established between the user device and the vendor device, or on global geo-positioning technology determining the user's proximity to the service desk, to decide transaction time. The potential user would still be informed of the average wait time in the queue.

In addition to the on-demand service that the vendor provides via the system, the vendor essentially ‘makes a bid’ or ‘makes an offer’ to the user for the user to use the service. It is within the scope of the invention that a user/purchaser may, using his device interface with the vendor system, propose a higher price he is prepared to pay to receiving even quicker or more highly prioritized service. A bidding and offer/counteroffer system may therefore be included for activation by either party.

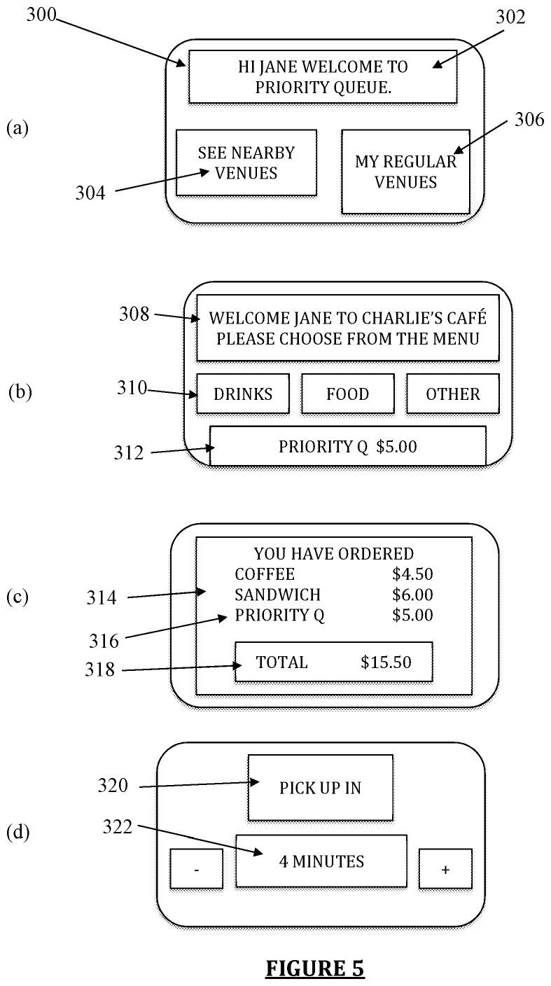

FIG. 6 illustrates the interface from the vendor's perspective. Here the vendor device, in this example a smartphone being operated by an enterprise manager, has a screen 400 for data entry using blocks 404 and 406. The vendor is a purveyor of tickets to a rock concert as noted in title block 402. Tapping block 404 leads to an input screen for the vendor to use in setting a fee to be paid by a purchaser electing priority queue service. The fee may be set at vendor's discretion, or may be guided by a fee calculating algorithm, which may be programmed to take into account supply/demand factors and the like. By tapping on block 406 below, the vendor is invited to input a brief annotation relating to the fee in block 404. This may be selected from a drop-down menu.

FIG. 6(b) illustrates an example of the content that may be placed in the boxes 402, 404 and 406.

FIG. 6(c) illustrates a screen seen on the purchaser device. Here the upper block shows the nature of the product offering 408. The middle block 410 shows the price set by the vendor for priority service and the lower block 412 the approximate wait time calculated by the system using available data as described previously.

Referring to FIG. 6(d), the purchaser proceeds directly to the priority counter, where they place their order, receiving priority attention and paying the nominated priority entry fee 410. There is no need to use the interface on the user device. The applicable wait time to endure before being attended to is displayed in box 414. This will then be broadcast to all users of the system at nearby venues utilizing the service. Therefore, users can see any current priority queues in the area. For example, a user may have paid for an airline ticket and when he gets to the airport, he sees a long queue. The user checks the app to see if the airline business has a priority queue on offer. If the airline has a priority queue on offer, the user will tap to enter the queue and proceed to the checkout and the price for using the priority queue will be transacted using a wireless method of known type.

According to the method chosen, all the required input data will be on the software. For example, at an entertainment event such as a major sporting contest, the device user chooses their drink and food and then additionally to use the priority service for the transaction. They would then pay for all three items at the physical checkout or by phone-managed payment means prior.

For such an event, the invention includes allowance for an attendee to obtain priority access to a plurality of individual vendors operating under the auspices of the event organiser, for example at a sports stadium. When purchasing a place in a priority ticketing queue, the prospective attendee may choose to include a plurality of further product offerings to be made available at the stadium and priority service for each one the attendee selects from an online menu. These offerings may include transport to and from the stadium, a priority entry queue, priority security screening, food and drink purchases and the like.

Further, businesses might consider what benefits an on-demand priority queuing system may bring to them. These include; improved purchaser service, improved business operations (employing additional staff to work in priority service), improved business reviews and satisfaction by purchasers, ability to generate more revenue.

Businesses might also consider that by selling a product in high demand, for instance an about to be launched new smartphone model, they may capitalize on the situation by charging a premium for a priority service that is directly commensurate with demand or popularity of the product.

The system can be adopted by any business and replicated, in other words, it helps to solve the problem of waiting for customer service on a global scale. It is imperative to address priority service queues on a day-to-day basis based on customer demand. This system gives leverage to businesses and purchasers whilst simultaneously addressing the intricacies of the timely provision of goods and services.

These embodiments merely illustrate some examples of the method, kit and apparatus of the invention providing means for the monitoring of queues and providing queuers with alternatives to waiting in a lengthy line. With the insight gained from this disclosure, the person skilled in the art is well placed to discern further embodiments by means of which to put the claimed invention into practice.

end

1. A system for providing customer service to purchasers queuing to access a product offering, the system comprising
a. a first location defining a start for a first queue joinable for receiving the product offering at a first price;
b. a second location defining a start of an alternative queue joinable for receiving said product offering at an alternative price differing from the first price; and
c. queue establishment means comprising a digital communications interface operably configured for:
i. receiving a queue establishment stimulus for creation of an alternative queue,
ii. responsive to said stimulus, establishing the alternative queue, and
iii. digitally communicating to potential purchasers notification of the establishment and location of the alternative queue,
wherein the system is configured for allowing online negotiation of alternative price value between said purchaser and vendor of the product offering.

2. A customer service system according to claim 1, wherein the stimulus is inputted by a vendor of the product offering, or by a purchaser seeking access to the offering.

3. A customer service system according to claim 1, wherein the stimulus is triggered automatically by the satisfying of a queue-establishment criterion.

4. A customer service system according to claim 3, wherein the establishment means further comprises data processing means operably programmed with executable program steps causing it to:
a. collect and process data relating to the first queue; and
b. apply a queue establishment criterion to the data and, on the basis of said data meeting the criterion, establish the alternative queue.

5. A system according to claim 4, wherein the data processing means is programmed to request, on a prioritized basis, an order in respect of the product offering from a purchaser in the alternative queue.

6. A customer service system according to claim 1, configured for receiving a value of the alternative price inputted by a purchaser.

7. (canceled)

8. A customer service system according to claim 6, configured for receiving an input from the vendor, responsive to the alternative price value inputted by the purchaser.

9. A customer service system according to claim 5, comprising means for inputting a negative value for the first price.

10. A customer service system according to claim 4, wherein the first queue is accessible via an internet website.

11. A customer service system according to claim 5, wherein the location of the alternative queue is identified by means of global positioning co-ordinates communicated to a purchaser who has made an input in relation to its establishment or alternative price.

12. A customer service system according to claim 10, wherein the alternative queue has a virtual location.

13. A customer service system according to claim 1, comprising digital communication means for providing a vendor of the product offering with comparative data pertaining to the first and alternative queues.

14. A computer-implementable purchaser queue management system comprising a temporarily locatable point of sale for a product offering, the point of sale being defined by a system computer configured to function as a mobile point of sale and for communicating with at least one group of remote computerized devices, a set location of a first queue for attendance by purchasers equipped with said remote devices and seeking access to the product offering at a first price; and executable program means for the system computer, or a remote device in communication with it, to initiate creation of an alternative queue at a temporary point of sale defined by the location of said system computer or remote device, when spaced from the first queue, at which point of sale the product offering is offered at an alternative price that differs from the first price,
wherein the system is configured for allowing online negotiation of the alternative price value between said purchaser and a vendor of the product offering.

15. The system of claim 14 wherein the executable program means initiates creation of the alternative queue by a remote device by causing dispatch of a wirelessly communicated request from a remote device to the system computer or remote device associated with the vendor, for creation of said alternative queue.

16. The system of claim 15 wherein the system computer or remote device associated with the vendor is configured to issue an invitation to join the alternative queue to a limited number of remote devices in the first group.

17. A computer-implementable method of purchaser queue management, comprising providing a computer running executable instructions that cause it to:
a. Offer access to a product offering available for purchase online at a first price;
b. Establish a first queue for joining by a prospective purchaser seeking access to said product offering at the first price;
c. Monitor said first queue for gathering queue-related data;
d. Based on an establishment criterion being met according to the data, establish an alternative queue for joining at an alternative price differing from the first price for a prospective purchaser to receive priority service in respect of said offering;
e. Receive and process a request from a prospective purchaser to join the alternative queue; and
f. Communicate queue status data to the purchaser in virtual real time,
wherein the system is configured for allowing online negotiation of the alternative price value between said purchaser and avendor of the product offering.

18. The method of claim 17 including causing the computer to evaluate the request against a predetermined joining criterion.

19. The method of claim 18, wherein the joining criterion relates to payment of the joining price by the requesting purchaser for being allocated a place in the alternative queue.

20-31. (canceled)

32. An automated method of servicing purchaser requests for a product offering, the method comprising the steps of:
a. Providing a network of digitally connectable communication-enabled devices, the devices including a computer, configured and programmed for operation by a vendor of a product offering, and at least one purchaser-operated communications device;
b. Allowing the vendor-operated computer, running software thereon, to set a price at which a purchaser associated with the purchaser operated device will receive prioritized attention for placing an order for said product offering;
c. Causing the purchaser-operated device to receive notification of an option to join a prioritized attention-receiving queue, for receiving the prioritized attention, and a fee for being placed in said prioritized queue;
d. Allowing the purchaser, via the purchaser-operated device, to communicate their election to join said queue at said fee; and
e. Responsive to said election, causing the vendor-operated computer to allocate a place in the queue to the purchaser operated device and to communicate said place and a queue status report to the purchaser-operated device,
wherein the system is configured for allowing online negotiation of the alternative price value between said purchaser and a vendor of the product offering.

33.-35. (canceled)
